(19) United States
(12) Patent Application Publication
(10) Pub. No.: US 2005/0123678 A1
(43) Pub. Date: Jun. 9, 2005

(54) Method for coating a surface of a continuous web with a coating powder

(76) Inventors: Juhaä Maijala, Jarvenpaa (FI); Johan Gron, Espoo (FI); Kaisa Putkisto, Tampere (FI); Vilho Nissinen, Numminen (FI); Pentti Rautiainen, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/507,436

(22) PCT Filed: Mar. 11, 2003
(86) PCT No.: PCT/FI03/00179

(30) Foreign Application Priority Data
Mar. 14, 2002 (FI) 20020479

(51) Int. Cl. B05D 1/12; B05D 3/12; B32B 25/02

(52) U.S. Cl. 427/180; 427/361; 428/295.1; 425/332

(57) ABSTRACT

The surface of a continuous web, the fibrous portion of which consists of papermaking fibres, is coated with a coating powder. The web is allowed to move between electrodes, which are in different potentials. A coating powder of inorganic material and polymeric binder material is applied on the surface of the web by utilizing the difference in the electric potential. The coated surface of the web is then finished. The coating powder comprises 10.1-99.5 wt.-% of inorganic material. A dry surface treated sheet material is thus formed.

### BACKGROUND OF THE INVENTION

The present invention relates to a method for coating a surface of a continuous web which fibrous portion consists of papermaking fibres, with a coating powder. The method comprises: Allowing the web to move between electrodes which are in different potentials, applying the coating powder comprising inorganic material and polymeric binder material on the surface of the web by utilizing the difference in the electric potential, and finishing the coated surface of the web. The present invention also relates to a dry surface treated sheet material comprising a substrate which fibrous portion consists of papermaking fibres, and a coating layer including inorganic material and polymeric binder material, and a dry-coating powder comprising inorganic material and polymeric binder material.

Publication EP 0982120 discloses a dry coated sheet and a method for producing a sheet. The sheet is coated by a powdery coating composition and inorganic particles. The powdery coating composition is formed of a resin consisting of particles having an average diameter of 0.1-30 μm. The average diameter of the inorganic particles is 1 nm-1 μm, and their share is 0.5-10% by weight based on the total amount of the powdery coating composition and the inorganic fine particles.

Publication FI 105052 and corresponding publication WO 00/03092 disclose a dry coating method in which a substrate is coated with a coating powder, which comprises calcium carbonate.

Publication WO 98/11999 discloses an ion blasting technique, which is aimed to transfer additional material on a surface of a material web.

U.S. Pat. No. 5,340,616 discloses a method in which an electric field is applied on the surface of the web to be coated and, at the same time, air having a relative humidity of 70-85% is blown against the surface of the web after the start of the coating operation but just prior to a time when the thin liquid film of coating impinges against the web.

The known defects of the prior art relate to the amount of the resin in a coating powder and the size of the agglomerates in the coating powder. The present invention is an improvement compared to the prior art. The method, dry surface treated sheet material, and a dry-coating powder are characterized in that the coating powder comprises 10.1-99.5 wt.-% of inorganic material.

General advantages related to a dry surface treatment process compared to conventional coated paper manufacturing processes are:
The dry surface treatment process allows considerable lower investments compared to the conventional processes. The manufacturing line is substantially shorter, and thus the line can be located in a smaller building. The conventional process can easily be replaced by the dry surface treatment process by rebuilding the old process, or the dry surface treatment process can be built on the place of the after-drying section which can be removed partly or entirely from a conventional layout. A normal space requirement of at least 20 meters for the after-drying section and on-line calendering disappears, and
The environmental aspects are also of importance. An eliminated water usage in the surface treatment process combined with a reduced or even eliminated water (e.g. a gas phase as dispersing medium) usage also during the coating component production are enormous advantages to the credit of the dry surface treatment process. Reduced energy consumption can also be achieved since water evaporation is eliminated and no after-drying section is needed.

### SUMMARY OF THE INVENTION

The specific advantages concerning the present invention are:
The use of the polymeric binder material in a coating powder is minimized. The low amount of the polymeric binder material makes possible substantially low raw material costs,
The coating powder does not contain large agglomerates and its charging properties are optimal, and
The coated product is not very sensitive in regard to the substrate and it can be varied to have different properties without changing the substrate. In other words, by changing the parameters of the coating powder different properties can be achieved to the coated product.

Generally speaking, in a conventional papermaking process, the substrate has the greatest effect on the final result of the coating process. In the dry surface treatment process, on the contrary, the coating layer has the greatest effect on the final result of the coating process. The dry surface treatment process can be used for production of paper with properties corresponding to conventional paper quality for example MFC (Machine Finished Coated) and LWC (Light Weight Coated) paper grades. There is even a possibility to have some other substrate than a substrate which fibrous portion consists of papermaking fibres. The coating powder is applied preferably at a moisture content of less than 15%. The dry surface treatment process eliminates the possibility to release internal stresses in the fibre network and roughen the surface, as happens in a conventional surface treatment process, since a dry layer is applied. The coating powder also stays on the surface of the paper and can perfectly cover the surface without possibilities to penetrate into the paper. A distinct interface between the coating layer and base paper can be observed in the cross-section of the coated paper.

The dry surface treatment process of paper or board substrates comprises dry coating powder application followed by a finishing step, for example thermomechanical fixing. The application of the coating powder utilizes an electric field to transfer the coating particles to the paper surface and to enable an electrostatic adhesion prior to the finishing. Both the final adhesion and the surface smoothening of the coating are executed simultaneously through thermomechanical treatment or another suitable treatment. Since the process consists of application, fixing, and smoothening steps without intermediate drying, the surface treatment process is very compact. The properties of the coating powder (e.g. composition and component properties) have also been developed along with the process.

Formerly both inorganic particles (e.g. ground CaCO₃, precipitated CaCO₃, kaolin, talc, TiO₂, etc.) and polymer binders (e.g. styrene-butadiene and acrylate copolymer binders etc.) have been prepared as separate stable water-based dispersions. When producing powder for the dry surface treatment process, the coating components are combined or prepared separately either as dispersions in a liquid phase (e.g. water etc.), prior to entering an evaporation or drying process, or in a gas phase (e.g. air etc.). There are several methods available to produce, refine, and combine the coating components. The mentioned possibilities of producing the coating powder components are summarized in table 1.

TABLE 1
Description of the component variations in different dispersing medium.

| Dispersion medium | Physical state |
|---|---|
| Liquid | Separate pigment and binder components |
| | Hybrid of pigment with binder |
| Gas | Separate pigment and binder components |
| | Hybrid of pigment with binder |

As seen from the table 1, the coating powder comprises either separate inorganic material particles and polymeric binder material particles or particles including both inorganic material and polymeric binder material (so-called hybrid particles). An average diameter of the material particles is chosen so that it is above of an average diameter of pores of a substrate to be coated. The average diameter of the material particles is usually 0.1-500 μm, preferably 1-15 μm.

The particle properties have a direct influence on the coating powder application, which includes a fluidized bed during powder transport and electrostatic deposition as an initial adhesion. For example, the powder drying process conditions have been found to greatly influence the particle size distribution of the coating powder. Aggregates in the range 5-500 μm after spray drying and 1-100 μm after freeze-drying have been produced. The average aggregate or particle size is generally smaller when freeze-drying and further reduced when applying a certain post-grinding. A particle size close to 10 μm is in most cases preferable in respect to charging properties. The coating powder material shall be taken into consideration because the components of the coating powder can have varying electrical properties, such as particle surface charging and discharging rate.

### BRIEF DESCRIPTION OF THE DRAWINGS

In the following, the invention will be described by means of examples and figures.

FIG. 1a is a SEM-picture which shows a dry-coated sheet of the invention in a top view.

FIG. 1b is a SEM-picture which shows a conventional coated sheet in a top view.

FIG. 2a is a SEM-picture which shows a dry-coated sheet of the invention in a cross-sectional view.

FIG. 2b is a SEM-picture which shows a conventional coated sheet in a cross-sectional view.

### DESCRIPTION OF THE PREFERRED EMBODIMENTS

In order to utilize the full potential of the dry surface treatment process, the coating powder components are preferably produced as dry or the preparation needs to be done in another carrier medium than water (e.g. air or an evaporable liquid). This is to be done to avoid excess evaporation costs and possible powder defects such as large agglomerates. The inorganic particles may be coated with the binder material or the polymeric binder material may be grafted onto the inorganic particle to form so-called hybrid particles.

The most profitable way could be a preparation of dry powder components without the need for drying, where the particle morphology is adjusted in the production process. Another possibility is to combine a dried binder with a pigment powder manufactured in gas phase. In that way, the binder part could also be prepared by grinding. Fine-sized polymeric particles can also be formed by synthesis in a gas phase, for example in supercritical carbon dioxide (sc-CO₂). The separation of the solvent from product is simplified because CO₂ reverts to the gaseous state upon depressurization, thus eliminating energy intensive drying steps. The selection of suitable monomers is quite large, including most of the typical polymer binders mentioned above. Also a range of polymerization mechanisms are possible. For example, dry powders from styrene, vinyl monomers and methyl methacrylate have been produced by precipitation polymerization, dispersion polymerization and emulsion polymerization. In all cases, the end product is dry powder readily recovered by venting CO₂. The typical particle size of the polymeric binder particles is between 0.4 and 10 μm.

As a result of the cost and quality requirements, the binder usage should generally be optimized to create possibilities for just enough connection points between the pigment particles and between the particles (e.g. pigment and binder particles) and the substrate without polymer overdosing. The coating powder comprises 10.1-99.5 wt-% (dry weight) of inorganic material and the rest is preferably polymeric binder material. The coating powder comprises preferably at least 70 wt.-% of inorganic material and more preferably at least 80 wt.-% of inorganic material. The coating powder comprises preferably at the most 99 wt.-% of inorganic material and more preferably at the most 95 wt.-% of inorganic material.

The high portion of the inorganic material requires optimization of the process parameters in the mixing phase to create a homogeneous and stable component blend without forming strong aggregates in the dry powder. These agglomerates could, due to their large size, give an uneven and too porous coating layer. For example, by coating with freeze-dried coating powder a more homogenous surface is achieved. The coating powder is in a substantially dry form (moisture content under 10 wt.-%), and it comprises air and the material particles whose portion in the air/particle mixture is above 1 vol.-%. The diameter of the particles is under 500 μm.

The fibrous portion of the continuous web to be treated consists of papermaking fibres. In the present application, the papermaking fibres refer to fibres obtained from trees, in other words, either fibres of a mechanical or chemical pulp or mixtures of those two. In this application, the dry surface treated sheet material refers to the coated substrate without reference to if it is in a web or a sheet form.

To strengthen the fastening of the coating powder to the web during the application of the dry coating powder it is advantageous to pre-treat the web. The pre-treatment may comprise rubbing, treating by corona, or moistening the web by suitable liquid substances, such as water, polyamide imide, hydrogen peroxide, or lime water. The fastening of the coating powder has different mechanisms, such as hydrogen bonds, oxidizing the surface of the web followed by forming of free radicals or a chemical reaction forming a new compound. The pre-treatment liquid is preferably sprayed from ducts in the form of fine fog particles towards the web to prevent excess moistening of the web.

The surface of the paper web to be coated may also be pre-treated by brushing. The fibres, which are located on the surface of the paper, are fibrillated to enhance the fixing of the coating powder on the web. The brushing has an effect on the web at least in three ways, namely enlarging the specific surface area, adjusting the roughness of the surface, and charging the surface by static electricity. The degree of fibrillation and the amount of static charging can be adjusted by adjusting the rotation speed and the pressing pressure of the brush. The desirable charge can be obtained by choosing the material of the brush accordingly. The brush may rotate clockwise or counter clockwise compared to the running direction of the web.

In dry surface treatment of paper and paperboard, the powder is sprayed through an area of strong electric field and high free-ion concentration to the surface of the substrate. The coating powder is put into the coating feeder chamber and transferred to the powder deposition unit with compressed air. The compressed air is used for many purposes such as powder fluidizing, transporting, and conditioning. As the complexity of the application equipment, the charging unit, and the coating powder properties vary; the importance of a continuous supply of clean and dry air also increases. The air quality (e.g. temperature and moisture variations) and powder piping can generate contaminants in the compressed air, which may cause process and quality problems. The contaminants in the compressed air can also consist of vapor, liquid, or solids.

The coating powder is charged in the powder deposition unit. A primary requirement for electrostatic powder deposition is generation of large quantities of gas ions for charging the aerosol particles. This is accomplished by means of a gaseous discharge or corona treatment.

The generation of a corona involves the acceleration of electrons to high velocity by an electric field. These electrons possess sufficient energy to release an electron from the outer electron shell when striking neutral gas molecules, thus producing a positive ion and an electron. This avalanche phenomenon is initiated around the discharge or corona electrode.

An electric field is created by the voltage application to the electrode pair. The electric field in the interelectrode space has three main purposes: (1) a high electric field near the electrode with a small radius of curvature leads to the generation of charging ions in an electrical corona, (2) the field provides the force that causes these ions to collide with and transfer their charge to the coating particles, and (3) it establishes the necessary force to attach the charged coating particles to paper. If the small radius electrode is negative (e.g. negative corona), electrons from the corona region move toward the grounded (e.g. positive) electrode and the positive ions move toward the negative electrode. To achieve a reversed polarity (positive corona), the positive ions move toward the grounded electrode and the electrons move toward the positive electrode with a small radius.

The powder is supplied to the application unit with compressed air or another transport medium that promotes particle charge. The transport medium can be added to the supply air through oxygen addition to the compressed air or entirely replaced by another gas. Also the moisture content and the temperature of the supply air can be varied to improve the charging effect in the corona region. This might further improve the powder transfer in the electric field to the substrate surface. A higher temperature of the supply air increases the ionization coefficient. The supply air temperature should be kept under the polymer glass transition temperature (Tₐᵢᵣ<T_{g} of the polymer) because otherwise the coating powder agglomerates. The moisture content of the supply medium must be kept below a relative humidity (RH) of 50% to avoid discharges and raise the medium pressure beyond 0.1 bar. Harmful discharges are prevented in this way.

Voltage and current are varied with the required distance between the charging and the grounding electrodes, the material properties (e.g. dielectric constants) of the electrodes, the powder composition (organic-inorganic ratio, dielectric constants of the powder etc.), the powder amount, the supply medium moisture content, and pressure. The voltage varies from 5 kV to 1000 kV and the current from 30 μA to 1000 A. The powder properties and the application concept guides setup of the charging electrodes. The charging electrodes are however either positive or negative.

In practice, the grounded electrode may be a static earthing plate or a moving earthing device. A moving earthing device is preferred because the used voltages and the speed of the web to be coated are restricted and the quality of the final coated product is affected when using the static earthing plate. The coating powder may tend to cake on the web at the location of the edge of the earthing plate. By using the moving device the above-mentioned problems can be avoided. The moving device can be a rotating device, for example an earthing roll, an endless conductive wire, or belt. The web to be coated may advance in a continuous manner on the surface of the earthing roll during the coating process. The earthing roll may form a nip with a hot roll, which at least partially melts the binder of the coating powder. The finishing can be finalized in the next nip formed by the hot calender roll and a resilient roll. The earthing roll, the hot roll and the resilient roll can form a calender stack. The web in contact with the earthing roll is earthed down to the nip formed by the earthing roll and the hot roll. It is possible that there are also other nips through which the web travels. The finishing can also be finalized by using chemicals, or a suitable radiation, for example UV radiation, to fix the coating powder to the web.

The application of the coating powder may be done by using a belt or a like. The belt is charged by a corona charging electrode to have an even charge all through the surface of the belt. The belt shall have sufficiently high resistivity because the belt shall maintain its charge. The charged belt catches the particles of the coating powder and conveys them over the web to be coated. The particles are released from the belt by using a corona charging electrode having an opposite polarity compared to the polarity of the corona charging electrode used for charging the belt.

One possibility to charge the coating powder instead of using corona is to transfer the particles of the coating powder by using a static electric field between a high voltage electrode and an earthed duct supplying the coating powder particles. The substrate is not charged by the field because there are no free ions and there is no need to ground the substrate. The voltage used is preferably 60-80 kV. A grounded heavy-duty grinder can be used instead of a grounded duct. The large agglomerates are ground to fine particles and it is possible to add some auxiliary substances to the grinder.

The application of the coating powder can be enhanced by directing the flow of the coating powder. Often the particles are blown substantially to the web direction. It is possible that some particles penetrate through the electric field without fastening to the web and cause dusting. When the application of the coating powder is made parallel to the direction of the electric field dusting is remarkably diminished. The parallel powder stream can also be used to overcome the air boundary layer. The coating powder can be pre-charged before creating the difference in the electric potential in the final stage between the surface of the substrate and the coating powder.

Some auxiliary substances can be sprayed simultaneously with the coating powder onto the web. They are preferably in a liquid form but also solids are used. The auxiliary substance is charged to have a similar charge as the coating powder and it is blown among the coating powder. The auxiliary substance may be for example water, lime water, cationic starch, polyvinylalcohol in a granular form or carboxymethylcellulose.

In the dry surface treatment process, it is also possible to coat both sides of the web simultaneously. To coat both sides of the web simultaneously, an earthing electrode can be replaced by an electrode having an opposite polarity compared to the first electrode. The web is between the two electrodes and hence the particles drawn by the electric field having an opposite sign place them on the surface of the web. If the first electrode is negative the second electrode on the opposite side of the web is positive and vice versa. When the first corona charge electrode is negative the particles of the coating powder charged by negative electrons of the negative corona charge electrode move towards the positive corona charge electrode which is located on the other side of the web. The difference in potentials of the two electric fields is remarkable, and thus those two electrodes strengthen the function of each other.

The dry coated substrate may also comprise more than one coating layer on the same side of the substrate. The layers can be different from each other. The charges, which are formed for the application of the coating powder, can be eliminated or changed to have a different sign after fixing the coating powder with heat and pressure. When a first application is done by a negative charge a second application can be made by a positive charge and hence the layers are adhered to each other properly due to the electric attraction.

In the case of an excess powder supply, the electrostatic deposition can be utilized to remove it. To remove an excess amount of the coating powder may be necessary for example when starting the process or changing production parameters. Secondary electrodes are used to accomplish the deposition. The coating powder has to be removed before its fixing on the web has been finalized. Before the fixing is finalized the particles of the coating powder are adhered to the web only by electric forces and hence they can be removed by using the secondary electrodes having an opposite charge compared to the particles of the coating powder. The electric forces are thus eliminated. The removing of the coating powder can be enhanced e.g. by air doctoring. The powder collection can be done for example through electrostatic precipitation or air suction. The removing of the particles may have prior treatments or local in situ treatments, which enhance the process. Also means for recycling may be used.

A considerable reduction of the polymer binder content in the dry powder has been achieved due to further optimized fixing conditions (e.g. surface moisturizing, moisture content of the web, dwell-time, surface temperature and linear load). The polymeric binder concentration and its thermal deformability during thermomechanical treatment determine paper properties such as a coating layer density, openness, smoothness, strength, and optical properties. A binder content of less than 10 wt.-% is in some cases enough to give a sufficient surface strength. The glass transition temperature (T_{g}) of the binding polymers have ranged from 20 to over 100° C., where the lowest glass transition temperature (T_{g}) has been restricted by the required drying and refining conditions. Usage of other binders, such as starch, has given certain desirable paper properties in combination with higher base substrate moisture content or moisturizing prior to the thermomechanical fixation. The moisture may dissolve the starch granule and allow it to work as a binder under certain process conditions, but less effective than the copolymer latex binder. Starch can be produced dry as a granule through grinding, but preferably dissolved in liquid to gain its binding properties.

The preferred ranges for the thermomechanical treatment are: The temperature of 80-350° C., the linear load of 25-450 kN/m and the dwell time of 0.1-100 ms (speed 150-2500 m/min; nip length 3-1000 mm). The fixation can be reinforced in different ways to achieve desired paper properties. In this novel process solution, the polymer also creates physical adhesion of the coating layer to the paper surface, which replaces the lack of a penetration effect and mechanical interlocking present in a conventional process. The thermomechanical treatment can be made by various calendering methods or calendering-like methods. The methods utilize nips formed between rolls, or substantially long nips formed between two counter surfaces. Examples of such nips are hard-nip, soft-nip, long-nip (e.g. shoe-press or belt calender), Condebelt-type calender and super-calender.

One of the most essential parts in the thermomechanical fixing is the non-adhesive property of the roll surfaces to avoid blocking, sticking, or other build-up of polymer based deposits. When powders with the polymer content less than 20 wt.-% are used, hard roll cover materials such as hard chrome or wolfram-carbide based are suitable. When powder with a high polymer contents are used, the roll cover must have better non-sticking properties, e.g. usage of Teflon based cover materials. Another way to avoid the above mentioned problem is to use a calender comprising a nip formed between a hard hot roll and a resilient roll. The web is conveyed to the nip so that the coating layer touches the resilient roll. The heat acts through the web melting the binder, especially the lower part of the coating layer thus enhancing the adherence of the coating powder.

An alternative to the heated roll is to use a suitable solvent to dissolve the binder, or a suitable radiation to melt the binder. The wave length of the radiation is chosen so that the radiation does not absorb into the web but into the coating powder. After the radiation unit there can be a calender to give a sufficiently strong pressure treatment. The roll in contact with the coating layer is a resilient roll.

Increased surface moisture content of the base paper may improve the powder deposition and fixing to the substrate surface. An incoming substrate moisture content (e.g. paper bulk moisture) can be maximized or adjusted to optimize the layer strength and other paper properties. For example, starch requires a higher moisture content than copolymer latex binders to reach equivalent surface strengths of the surface treated paper or board. This can be explained by the need to solubilize the starch to give binding properties and then an excess energy is required for the water evaporation. The surface moisture can also be adjusted through nozzle application onto the substrate surface. Then only a water amount evaporating in the fixing process is applied and the moisture balance over the fixing stage remains constant. The nozzle application can be done before the powder application or the thermomechanical fixing.

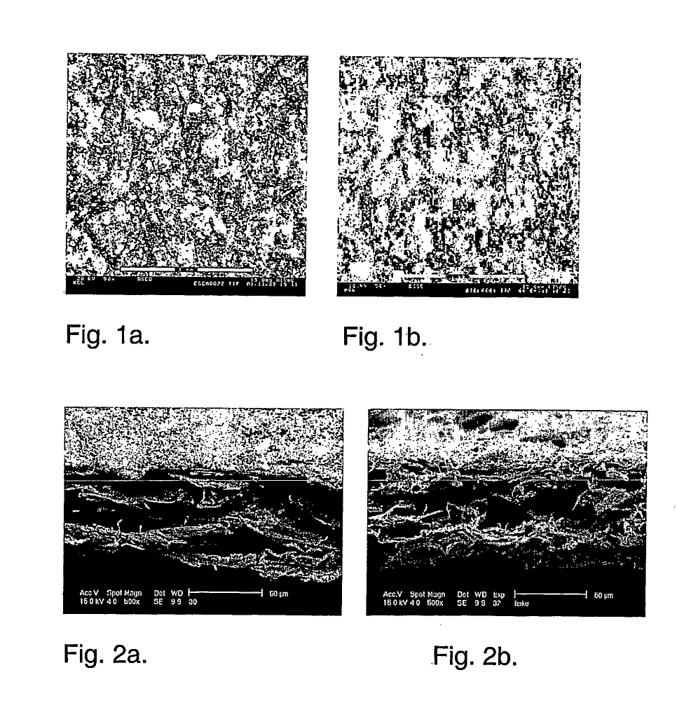

The SEM-pictures of dry surface treated papers and the conventional film coated papers are shown in FIGS. 1 and 2. The surfaces of both papers are quite similar with coverage rates between 70% and 75% at a coat weight of 5-6 g/m²/side (FIGS. 1a and 1b). With an optimal particle size, it is almost impossible to detect any differences in the cross-sections obtained from a dry surface treated paper with a freeze-dried powder and a conventional coated paper (FIGS. 2a and 2b).

### EXAMPLE 1

The paper quality of the conventional coating process and the dry surface treatment process were compared. The dry surface treatment process can be used for production of paper with properties corresponding to conventional paper quality for example MFC (Machine Finished Coated) and LWC (Light Weight Coated) paper grades as shown in table 2. The fixing conditions used to reach the paper properties reported in table 2 were the following:
The speed of the machine: 17 m/min (a laboratory machine) with a scaled dwell-time nip to a production speed of 1200 m/min.
The surface temperature of the roll: 200° C.
the linear load in the calendering nip: 20 kN/m (a laboratory machine), scaled to a production linear load of 400 kN/m.

The moisture content of the base sheet: 7%.

TABLE 2
Paper properties achieved with conventional (MSP combined with 2-nip
soft-calender for MFC and multinip calender for LWC) and dry surface
treatment (DST) methods.

| Paper grade | MFC | | LWC | |
|---|---|---|---|---|
| Coating method | Conventional | DST | Conventional | DST |
| Basis weight (g/m2) | 48 | 44 | 60 | 60 |
| Coat weight (g/m/side) | 5.5 | 6.0 | 9.0 | 8.0 |
| Coverage (%), BSE-SEM | 75 | 75 | 85 | 85 |
| Surface strength (m/s), IGT | 0.35 | 0.45 | 0.35 | 0.45 |
| Smoothness (μm), PPS-s10 | 5.5 | 5.4 | 1.0 | 1.2 |
| Gloss (%), Hunter | 30 | 30 | 60 | 57 |
| Air permeability (ml/min), | 11 | 200 | 10 | 70 |
| Bendtsen | | | | |
| Oil absorption (g/^{m2}), | 3 | 10 | 4 | 7.5 |
| Cobb-Unger 6s | | | | |
| Folding strength (no) | 2.0 | 1.5 | 1.8 | 2.0 |
| Opacity (%) | 84 | 80 | 91 | 90 |
| Brightness, ISO (%) | 77 | 70 | 77 | 75 |

### EXAMPLE 2

The production costs of the conventional coating and the dry surface treatment process were compared. In this example the polymer content is 10 pph (pph=parts per hundred). When the polymer content is on a low level the costs are dramatically reduced (Table 3). When targeting MFC and LWC paper grades, the required quality can be reached with formulations shown in table 2. The costs of the dry powder formulations is on the same or even lower level than for conventional formulations.

TABLE 3
Rough cost estimation for dry surface treatment and conventional
formulations.

| Coating color | Composition | Cost (EUR/dry tons) |
|---|---|---|
| Conventional | CaCO₃, Kaolin, Latex, Starch, | 297 |
| coating | Stearate, | |
| color 1 | Hardener, OBA | |
| Conventional | CaCO₃, Kaolin, Latex, Stearate, | 318 |
| coating color 2 | Hardener, OBA | |
| Dry surface | CaCO₃, Polymer pigment, Latex | 562 |
| treatment color 1 | (70/30/30 pph) | |
| Dry surface | CaCO₃, Latex (100/30 pph) | 350 |
| treatment color 2 | | |
| Dry surface | CaCO₃, Latex (100/10 pph) | 227 |
| treatment color 3 | | |

The dry surface treatment allows considerable savings to be made in the base sheet composition compared to any other technique. The low, or almost negligible, mechanical stress on the sheet combined with no rewetting during the coating application eliminates the largest sources for web breaks. In table 4, the base sheet composition, production cost, and investment cost are compared for different surface treatment techniques (e.g. blade, MSP, spray and dry surface treatment methods). The potential for raw material costs savings in combination with a potential for increased production efficiency makes the dry surface treatment process desirable in the future. The improvement in total net efficiency (e.g. the shutdowns, web breaks and finishing broke amounts are subtracted from the total production) is considerable as a result of eliminated after-drying section and wetting of the web (Table 4).

TABLE 4
Process comparison in respect to base paper composition, production
(raw material, energy and efficiency) and investment costs. Blade
and MSP (Metered Size Press) can be considered as examples of
industrial standard methods, while spray (e.g. non-contact) and
dry surface treatment are novel methods.

| | MFC | | | | LWC | | | |
|---|---|---|---|---|---|---|---|---|
| Paper grade | | | Spray | | | | Spray | |
| Coating | | | (Non | | | | (Non | |
| methods | Blade | MSP | C) | DST | Blade | MSP | C) | DST |
| Base Paper | | | | | | | | |
| Composition | | | | | | | | |
| Mechanical | ≦70 | ≦90 | ≦90 | ≦100 | ≦70 | ≦90 | ≦90 | ≦100 |
| pulp, % | | | | | | | | |
| Deinked | ≦20 | <100 | <50 | ≦100 | ≦20 | <100 | <50 | ≦100 |
| pulp, % | | | | | | | | |
| Kraft pulp, % | ≧30 | ≧15 | ≧15 | ≧0 | ≧30 | ≧15 | ≧15 | ≧0 |
| Filler | <10 | ≦15 | ≦15 | ≦20 | <10 | ≦15 | ≦15 | ≦20 |
| amount, % | | | | | | | | |
| Production | | | | | | | | |
| costs | | | | | | | | |
| Base paper raw | 110 | 100 | 100 | 90 | 100 | 90 | 90 | 80 |
| material, % | | | | | | | | |
| Coating raw | 110 | 100 | 95 | 80 | 100 | 95 | 95 | 85 |
| material, % | | | | | | | | |
| Energy, % | 105 | 100 | 99 | 95 | 100 | 95 | 94 | 90 |
| Total net | ≦83 | ≦84 | ≦85 | ≦87 | ≦82 | ≦83 | ≦84 | ≦87 |
| efficiency, % | | | | | | | | |
| Investment | | | | | | | | |
| costs | | | | | | | | |
| Production | 105 | 100 | 99 | 90 | 100 | 90 | 89 | 80 |
| line, % | | | | | | | | |

### EXAMPLE 3

LWC paper was manufactured by a dry surface treatment process. The coating powder contained less than 10 wt.-% of a polymeric binder, namely styrene-butadiene (60/40 wt.-%). The glass transition temperature (T_{g}) of the polymeric binder was 20-40° C. The average diameter of the polymeric particles in a stable water-based dispersion was 0.15 μm. The inorganic portion of the coating powder consisted of 30 wt-% of kaoline and 70 wt.-% of GCC (CaCO₃). The grain size distribution of the inorganic material was such that 90 wt.-% of the particles had the average diameter of less than 2 μm. The powder-based coating material was formed by a freeze-drying process.

The dry surface treatment process was executed in a speed of 1200 m/min. The coating powder was applied to the web direction at both sides of the web by using pressurized air. An electric field was formed between a positive and negative electrode between which the web travelled. The coating powder was pre-charged before bringing it to the final electric field. The particles of the coating powder adhered to both sides of the web due to the electric forces, and thus a double-sided coating was achieved. The pressurized air was recycled back to the process.

The surface treatment of the web was finalised in a calender with hard rolls. The linear load was 150 kN/m and the temperature of the rolls was 200° C. The surface roughness of the hard-metal rolls was at least Rₐ<0.1 μm.

A dry surface treated paper having properties similar to the LWC paper was achieved.

The invention is not restricted to the description above, but the invention may vary within the scope of the claims.

1-19. (canceled)

20. A method for coating a surface of a continuous paper or board web formed of papermaking fibers, with a dry coating powder, the method comprising the steps of:
moving the continuous paper or board web between electrodes which are at different electrical potentials;
applying the dry coating powder on to a first surface of the continuous paper or board web by utilizing the difference in the electric potential, wherein the dry coating powder is formed from 70-99% inorganic material having an average particle size of 0.1-500 μm, and wherein the dry coating powder is comprised of 1-30% polymeric binder material; and
finishing the dry coating powder on the surface of the paper or board web.

21. The method of claim 20, wherein the the dry coating powder is formed from 80-95% inorganic material.

22. The method of claim 20, wherein the the dry coating powder is formed by freeze-drying.

23. The method of claim 20 wherein the the dry coating powder has an average particle size of 1-15 micrometers.

24. The method of claim 20 wherein the continuous paper or board web is caused to travel at a speed of 1,200 to 2,500 m/min.

25. The method of claim 20 wherein the polymeric binder material has a glass transition temperature of 20° C. to about 100° C.

26. The method of claim 20 wherein the dry coating powder has a moisture content of less than 15%.

27. The method of claim 20 further comprising the step of pre-charging the dry coating powder.

28. The method of claim 20 wherein the step of finishing further comprises simultaneously adhering and smoothing the dry coating powder to form a first coated surface of the web, by passing the web through a nip formed by a hot hard roll and a moving earthing member and subjecting the dry coating powder on the web to a temperature of 80-350° C., a linear nip load of 25-450 kN/m and a nip dwell time of 0.1-100 ms.

29. The method of claim 28, further comprising the step of, after finishing the dry coating by simultaneously adhering and smoothing the dry coating powder to form the first coated surface of the web, treating the first coated surface at least in a nip formed between a heated roll and a resilient roll.

30. The method of claim 28 further comprising the step of, after finishing the dry coating by simultaneously adhering and smoothing the dry coating powder to form the first coated surface of the web, treating the first coated surface in a substantially long nip formed between two counter surfaces.

31. A method for coating a surface of a continuous paper or board web formed of papermaking fibers with a dry coating powder, the method comprising the steps of:
forming the dry coating powder from 70-99% inorganic material having an average particle size of 0.1-500 μm and a polymeric binder material forming 1-30% of the dry coating powder;
preparing a first surface of the paper or board web to receive the dry coating powder by a process which changes the surface properties of the paper or board web;
transporting the dry coating powder as a more than 1% by volume mixture with air;
allowing the web to move between electrodes, which are at different potentials;
spraying the dry coating powder through an electric field and a free-ion concentration to the surface of the paper or board web which has been prepared to receive the dry coating powder, said spraying taking place along the direction of the strong electric field, while the paper or board web is backed by a moving earthing device; and
finishing the dry coating powder by simultaneously adhering and smoothing the dry coating powder to form a first coated surface of the web, by passing the web through a nip formed by a hot hard roll and the moving earthing member, and subjecting the dry coating powder on the web to a temperature of 80-350° C., a linear nip load of 25-450 kN/m and a nip dwell time of 0.1-100 ms.

32. The method of claim 31, wherein the the dry coating powder is formed from 80-95% inorganic material.

33. The method of claim 31 wherein the the dry coating powder has an average particle size of 1-15 micrometers.

34. The method of claim 31, wherein the the dry coating powder is formed by freeze-drying.

35. The method of claim 31, wherein the continuous paper or board web is caused to travel at a speed of 1,200 to 2,500 m/min.

36. The method of claim 31, wherein, the organic material has a glass transition temperature of 20° C. to about 100° C.

37. The method of claim 31, wherein the dry coating powder has a moisture content of less than 15%.

38. The method of claim 31, further comprising the step of pre-charging the dry coating powder.

39. The method of claim 31, further comprising the step of, after finishing the dry coating by simultaneously adhering and smoothing the first coated surface of the web, treating the first coated surface at least in a nip formed between a heated roll and a resilient roll.

40. The method of claim 31 further comprising the step of, after finishing the dry coating by simultaneously adhering and smoothing the dry coating powder to form a first coated surface of the web, treating the first coated surface in a substantially long nip formed between two counter surfaces.

41. The method of claim 31 wherein the first side and a second side of the web are coated simultaneously.

42. The method of claim 31 wherein the first side and a second side of the web are coated sequentially.

43. The method of claim 31 wherein at least one additional layer is formed on the first coated surface by a dry surface treatment process.

44. A dry surface treated sheet material comprising:
a substrate, the fibrous portion of which consists of papermaking fibers; and
a coating layer on the substrate, wherein the coating layer comprises 70-99 wt. % of inorganic material, and 1-30% polymeric binder material.

45. The dry surface treated sheet material of claim 31, wherein the coating layer comprises 80-95 wt. % of inorganic material.

46. A dry-coating powder comprising a mixture containing 70-95% inorganic material having an average particle size of 1-15 micrometers, the mixture including a polymeric binder material forming 5-30% of the dry-coating powder.

47. The dry-coating powder of claim 45 wherein the mixture contains 80-95% inorganic material
